(19) United States
(12) Patent Application Publication
(10) Pub. No.: US 2024/0169657 A1
(43) Pub. Date: May 23, 2024

(54) INFORMATION PROCESSING APPARATUS, INFORMATION PROCESSING METHOD, INFORMATION PROCESSING PROGRAM, AND INFORMATION PROCESSING SYSTEM

(71) Applicant: SONY GROUP CORPORATION, TOKYO (JP)

(72) Inventors: KOJI NISHIDA, TOKYO (JP); NORIAKI TAKAHASHI, TOKYO (JP); TAKAAKI SUZUKI, TOKYO (JP); YUTO KOBAYASHI, TOKYO (JP); DAISUKE IRIE, TOKYO (JP)

(21) Appl. No.: 18/549,324

(22) PCT Filed: Feb. 10, 2022
(86) PCT No.: PCT/JP2022/005356

§ 371 Date: Sep. 6, 2023

(30) Foreign Application Priority Data
Mar. 17, 2021 (JP) 2021-043193

(51) Int. Cl. G06T 15/06; G06T 3/4046; G06T 3/4053; G06T 5/60; G06T 5/70; G06T 15/00

(52) U.S. Cl. CPC G06T 15/06; G06T 3/4046; G06T 3/4053; G06T 5/60; G06T 5/70; G06T 15/005; G06T 2207/20012; G06T 2210/36

(57) ABSTRACT

To render high-quality model data by ray tracing in a short time. An information processing apparatus includes: a pre-rendering unit that pre-renders model data by ray tracing and generates a pre-rendered image; a prediction unit that predicts a difficulty level of restoration in the pre-rendered image; a rendering condition determination unit that determines a rendering condition on the basis of the difficulty level of the restoration and generates an adaptive control signal for setting the rendering condition, the rendering condition specifying resolution and samples per pixel (SPP) for each of elements in the pre-rendered image; a rendering unit that generates an adaptively rendered image by rendering the model data by ray tracing in accordance with the rendering condition for each of the elements set to the adaptive control signal; and a rendered image restoration unit that restores the adaptively rendered image by super resolution and denoising and generates a final rendered image.

### TECHNICAL FIELD

The present disclosure relates to an information processing apparatus, an information processing method, an information processing program, and an information processing system for rendering model data by ray tracing.

### BACKGROUND ART

General path tracing (ray tracing) uses a Monte Carlo method of randomly calculating a fixed number of samples per pixel (SPP). In general, about 1000 light rays per pixel (1000 SPP) are tracked. In that case, it is necessary to calculate 4000×2000×1000 light rays for rendering a 4K image. In this context, conventional adaptive sampling predicts errors in a rendering result after calculating a certain number of samples (√1000=32) and adds samples when the errors exceed a threshold. Then, it cancels the addition of samples when the errors drop below the threshold.

In this regard, pre-rendering with 1 SPP first generates a noisy image according to Non-Patent Literature 1. A deep neural network (DNN) for predicting a sampling map is learned by inputting the noisy image and an image obtained by denoising it. The sampling map refers to an image output to indicate how difficult the pixel rendering is (i.e., how many SPP are required for properly rendering the pixel). Next, main rendering is performed based on the sampling map. The number of SPP at this time is an optimal value for each pixel. The number of SPP is larger than that at the pre-rendering time (1 SPP) and is much smaller than that at the normal time (1000 SPP). A noise-cancelling (denoising) DNN is learned by inputting the last output rendered image. The two DNNs, sampling map prediction DNN and denoising DNN, are optimally cooperated and learned so as to reduce errors in a final result in Non-Patent Literature 1.

Patent Literature 1 has disclosed adaptive sampling configured to learn a DNN for predicting a sampling map on the basis of a noisy image generated by pre-rendering with low SPP (about 1 SPP) and an image obtained by denoising it as in Non-Patent Literature 1.

Patent Literature 2 has disclosed a method of first performing low-resolution display and gradually increasing the resolution in rendering via a network. Only the resolution is changed and no restoration processing is performed in Patent Literature 2. That is, the rendering reduction rate is determined simply based on a transmission band width or rendering speed.

According to Patent Literature 3, anti-aliasing is performed by a multi-sample anti-aliasing (MSAA) rendering method when changing the resolution and performing rendering in accordance with a position based on the center of the pixel and an importance level of a subject in a head mounted display (HMD). Only the resolution is changed and the restoration is merely accumulation and averaging in Patent Literature 3. That is, the rendering reduction rate is not predicted in accordance with loss after the restoration.

### CITATION LIST

### Patent Literature

Patent Literature 1: U.S. patent Ser. No. 10/706,508
Patent Literature 2: Japanese Unexamined Patent Application Publication No. 2013-533540
Patent Literature 3: Japanese Unexamined Patent Application Publication No. 2020-510918

### Non-Patent Literature

Non-Patent Literature 1: Alexandr Kuznetsov, Nima Khademi Kalantari, and Ravi Ramamoorthi, “Deep Adaptive Sampling for Low Sample Count Rendering”, [online], 2018, Eurographics Symposium on Rendering 2018 Volume 37 (2018) Number 4, [19 Feb. 2021 search], Internet <URL: https://people.engr.tamu.edu/nimak/Data/EGSR18_Sampling.pdf>

### DISCLOSURE OF INVENTION

### Technical Problem

According to Non-Patent Literature 1 and Patent Literature 1, a sampling map for adaptively controlling only the SPP is predicted. However, the effect of reducing the calculation time has a limitation even when adaptively changing only the SPP.

In view of the above-mentioned circumstances, it is an object of the present disclosure to render high-quality model data by ray tracing in a short time.

### Solution to Problem

An information processing apparatus according to an embodiment of the present disclosure includes:
a pre-rendering unit that pre-renders model data by ray tracing and generates a pre-rendered image;
a prediction unit that predicts a difficulty level of restoration in the pre-rendered image;
a rendering condition determination unit that determines a rendering condition on the basis of the difficulty level of the restoration and generates an adaptive control signal for setting the rendering condition, the rendering condition specifying resolution and samples per pixel (SPP) for each of elements in the pre-rendered image;
a rendering unit that generates an adaptively rendered image by rendering the model data by ray tracing in accordance with the rendering condition for each of the elements set to the adaptive control signal; and
a rendered image restoration unit that restores the adaptively rendered image by super resolution and denoising and generates a final rendered image.

In accordance with the present embodiment, not only the SPP but also the resolution are adaptively controlled for each of the elements. This makes it possible to predict an optimal combination of SPP and resolution for each of the elements, perform adaptively rendering and restoration (denoising and super resolution), and outputs the final rendered image at high speed while keeping the image quality.

The rendering condition may further specify the number of images, a bounce rate, the number of refractions in internal transmission, a noise random number sequence, bit depth, time resolution, on/off of light components, on/off of anti-aliasing, and/or the number of sub-samples.

This allows specifying a more optimal rendering condition for each of the elements. Adaptive rendering can be performed at a higher efficiency or under a condition desired by a user.

The rendering condition determination unit may determine the rendering condition on the basis of image processing, a point of interest, an importance level of a subject, and/or display information.

This allows specifying a more optimal rendering condition for each of the elements. The condition can be predicted more simply with lighter weight. Moreover, the accuracy of the rendering condition can be improved, combined with a condition prediction deep neural network (DNN).

The rendering condition determination unit may determine the rendering condition for each of the elements, for each pixel, for each patch including a plurality of pixels, or for each object region.

Determining the rendering condition for each region including the plurality of pixels can improve the accuracy of the adaptive control signal and also keep continuity between adjacent pixels. Setting the rendering condition for each object can determine the rendering condition following edges with less overflow. It can improve the accuracy of predicting the rendering condition and reduce the calculation time.

The rendering condition determination unit may determine the rendering condition for each of some of the elements, and
the rendering condition for each of the others of the elements may be determined in advance.

This can reduce the calculation time, increase the speed of the output processing for each frame, and achieve rendering in real time.

The prediction unit may input the pre-rendered image to a condition prediction deep neural network (DNN) and predicts a difficulty level of restoration for each of the elements, and
the rendered image restoration unit may input the adaptively rendered image and the adaptive control signal to a restoration DNN learned simultaneously with the condition prediction DNN and generates a final rendered image.

First of all, a condition prediction coefficient to uniformly output the target SPP and the target resolution on the full screen is set. Then, an image restoration coefficient for restoration (denoising and super resolution) to predict a training image is learned, using a result image obtained by rendering with uniform target SPP and target resolution on the full screen as an image to learn. This allows simultaneous learning of the condition prediction DNN and the restoration DNN.

The prediction unit may predict a sampling map indicating a difficulty level of restoration for each of the elements in the pre-rendered image, and
the rendering condition determination unit may generate the adaptive control signal on the basis of the sampling map.

Generating the adaptive control signal on the basis of the sampling map indicating the difficulty level of restoration for each of the elements can generate a suitable adaptive control signal in accordance with the difficulty level of restoration. For example, an adaptive control signal with a rendering condition of relatively high SPP and high resolution can be generated for an element having a high difficulty level of restoration. This allows output of a final rendered image with the same image quality as a goal image.

The prediction unit may predict a sampling map of the resolution and a sampling map of the SPP, and
the rendering condition determination unit may set a rendering condition of the resolution on the basis of the sampling map of the resolution and sets a rendering condition of the SPP on the basis of the sampling map of the SPP.

In a case where two sampling maps, a sampling map of the resolution and a sampling map of the SPP, have been predicted, the rendering condition determination unit may specify resolution and SPP especially without conversion.

The prediction unit may predict the sampling map that is one-dimensional, and
the rendering condition determination unit may set the rendering condition of the resolution and the rendering condition of the SPP on the basis of the one-dimensional sampling map.

The rendering condition determination unit only needs to specify a combination of resolution and SPP in accordance with an arbitrary conversion formula from the predicted one-dimensional sampling map.

The SPP of the pre-rendered image may be lower than the SPP of the final rendered image.

This allows high-speed output of the final rendered image.

The resolution of the pre-rendered image may be lower than the resolution of the final rendered image.

This allows high-speed output of the final rendered image.

An information processing method according to an embodiment of the present disclosure includes:
pre-rendering model data by ray tracing and generating a pre-rendered image;
predicting a difficulty level of restoration in the pre-rendered image;
determining a rendering condition on the basis of the difficulty level of the restoration and generates an adaptive control signal for setting the rendering condition, the rendering condition specifying resolution and samples per pixel (SPP) for each of elements in the pre-rendered image;
generating an adaptively rendered image by rendering the model data by ray tracing in accordance with the rendering condition for each of the elements set to the adaptive control signal; and
restoring the adaptively rendered image by super resolution and denoising and generating a final rendered image.

An information processing program according to an embodiment of the present disclosure causes a processor of an information processing apparatus to operate as:
a pre-rendering unit that pre-renders model data by ray tracing and generates a pre-rendered image;
a prediction unit that predicts a difficulty level of restoration in the pre-rendered image;
a rendering condition determination unit that determines a rendering condition on the basis of the difficulty level of the restoration and generates an adaptive control signal for setting the rendering condition, the rendering condition specifying resolution and samples per pixel (SPP) for each of elements in the pre-rendered image;
a rendering unit that generates an adaptively rendered image by rendering the model data by ray tracing in accordance with the rendering condition for each of the elements set to the adaptive control signal; and
a rendered image restoration unit that restores the adaptively rendered image by super resolution and denoising and generates a final rendered image.

An information processing system according to an embodiment of the present disclosure includes:
a pre-rendering unit that pre-renders model data by ray tracing and generates a pre-rendered image;
a prediction unit that predicts a difficulty level of restoration in the pre-rendered image;
a rendering condition determination unit that determines a rendering condition on the basis of the difficulty level of the restoration and generates an adaptive control signal for setting the rendering condition, the rendering condition specifying resolution and samples per pixel (SPP) for each of elements in the pre-rendered image;
a rendering unit that generates an adaptively rendered image by rendering the model data by ray tracing in accordance with the rendering condition for each of the elements set to the adaptive control signal; and
a rendered image restoration unit that restores the adaptively rendered image by super resolution and denoising and generates a final rendered image.

### BRIEF DESCRIPTION OF DRAWINGS

FIG. 1 A diagram showing configuration of an information processing apparatus according to an embodiment of the present disclosure.

FIG. 2 A diagram showing an operation flow of the information processing apparatus.

### MODE (S) FOR CARRYING OUT THE INVENTION

Hereinafter, embodiments of the present disclosure will be described with reference to the drawings.

### 1. CONFIGURATION OF INFORMATION PROCESSING APPARATUS

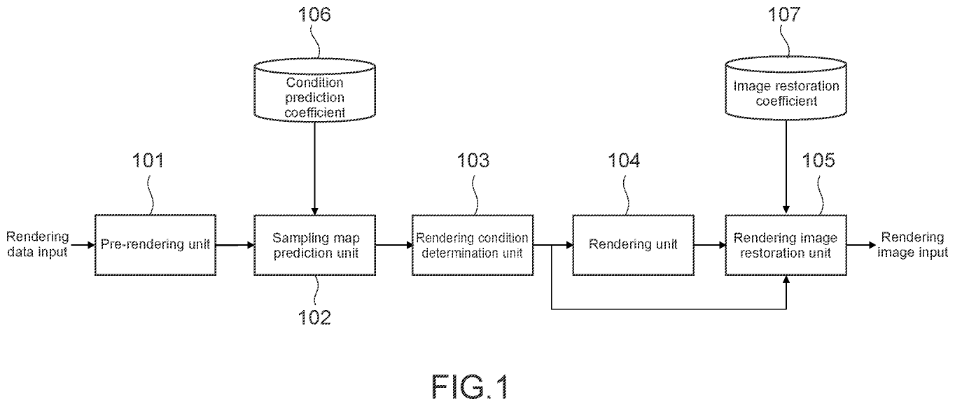

FIG. 1 shows a configuration of an information processing apparatus according to an embodiment of the present disclosure.

An information processing apparatus 100 is an apparatus that renders an image to be displayed on a 3D display capable of displaying a 3D image, for example. The information processing apparatus 100 is built in the 3D display or externally connected to the 3D display, for example. The information processing apparatus 100 operates as a pre-rendering unit 101, a sampling map prediction unit 102, a rendering condition determination unit 103, a rendering unit 104, and a rendered image restoration unit 105 by a processor loading an information processing program recorded on a ROM to a RAM and executing it.

### 2. OPERATION FLOW OF INFORMATION PROCESSING APPARATUS

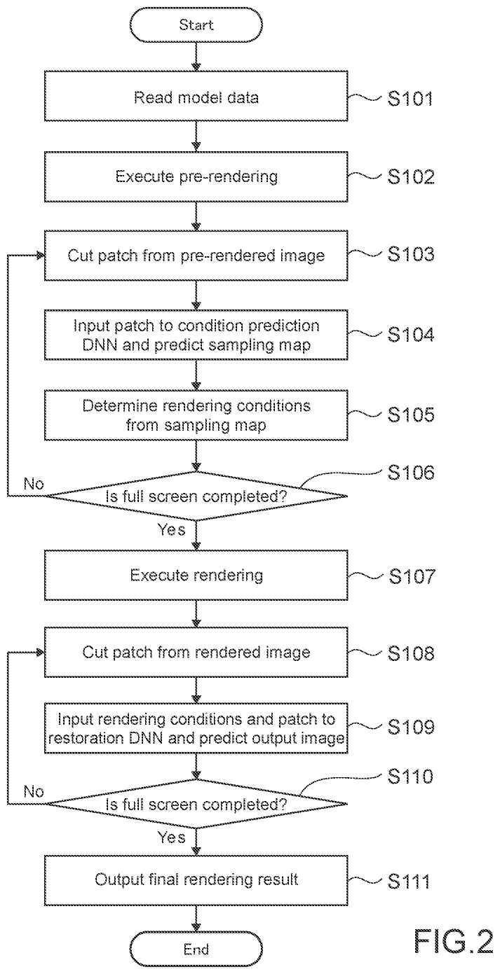

FIG. 2 shows an operation flow of the information processing apparatus.

The information processing apparatus 100 repeatedly executes processing following Step S101 on a frame-by-frame basis.

Step S101: Read Model Data

The pre-rendering unit 101 reads model data input as data about a rendering target. The model data is, for example, 3D CG model data.

Step S102: Execute Pre-Rendering

The pre-rendering unit 101 pre-renders the input model data by ray tracing and generates a pre-rendered image. The pre-rendering unit 101 pre-renders the model data, for example, at the same resolution as output resolution (i.e., the resolution of the final rendered image that should be output) and at low SPP, e.g., about 1 SPP. The pre-rendering unit 101 may pre-render the model data at resolution (e.g., ¼ or 1/16) lower than the output resolution and/or at SPP higher than 1. The pre-rendered image generated by the pre-rendering unit 101 is a noisy rendered image. The pre-rendering unit 101 may further generate various arbitrary output variable (AOV) images (i.e., image for each of elements such as depth, normal line, albedo, diffuse scattering, and reflection).

The pre-rendering unit 101 inputs the pre-rendered image to the sampling map prediction unit 102. The sampling map prediction unit 102 is a condition prediction DNN that predicts a sampling map representing a difficulty level (difficulty) of rendering on the basis of the input noisy pre-rendered image.

Step S103: Cut Patch from Pre-Rendered Image

The sampling map prediction unit 102 scans the pre-rendered image and cuts a plurality of patches from the pre-rendered image. The patch size equals the input patch size of the condition prediction DNN. For example, the sampling map prediction unit 102 only needs to cut the patch by sequentially raster scanning from the upper left side of the pre-rendered image.

Step S104: Input Patch to Condition Prediction DNN and Predict Sampling Map

The sampling map prediction unit 102 inputs the cut-out patch to the condition prediction DNN and predicts a sampling map. The sampling map shows a difficulty level (difficulty) of rendering. In other words, the sampling map prediction unit 102 predicts a difficulty level of restoration in the pre-rendered image. The sampling map prediction unit 102 predicts the sampling map by using a condition prediction coefficient 106 learned in advance. In a case of learning using not only the pre-rendered image but also various AOV images, the sampling map prediction unit 102 also cuts a patch of the corresponding AOV image and inputs it to the condition prediction DNN.

Here, the condition prediction coefficient 106 will be described. The condition prediction coefficient 106 performs learning by using a rendered image at high SPP and high resolution, which has been generated from numerous CG models, as a training image, and inputting a rendered image at low SPP (e.g., 1 SPP) and low resolution (e.g., ¼ or 1/16) and a restoration image obtained by restoring it by a restoration DNN (denoising and super resolution). A specific learning procedure of the condition prediction coefficient 106 will be described. First of all, the condition prediction coefficient 106 is set to uniformly output an image at target SPP (e.g., 4 SPP) and target resolution (e.g., 4K) on the full screen. Then, an image restoration coefficient 107 for restoration (denoising and super resolution) for predicting a training image is learned using an image as a result of rendering at the target SPP and the target resolution on the full screen as an image to learn. A difference between an inference image output as a result of this learning and the training image is loss. Next, the condition prediction coefficient 106 is learned so as to reduce this loss. At this time, the condition prediction coefficient 106 calculates a sampling map so that the average SPP and average resolution on the full screen become target SPP and target resolution by increasing the SPP and resolution where the loss is higher and reducing the SPP and resolution where the loss is lower. Then, rendering is performed again, the image restoration coefficient 107 is learned, and the loss is updated in accordance with the sampling map. Then, the condition prediction coefficient 106 and the image restoration coefficient 107 are repeatedly predicted until the loss falls within an allowable range. In this manner, the condition prediction DNN and the restoration DNN are simultaneously learned.

In this manner, the image at low SPP and low resolution is rendered, and learning as to a case where denoising (also called noise reduction (NR)) and super resolution (SR) are simultaneously performed is performed. Moreover, learning may use various AOV images, not limited to the input of the rendered image.

The sampling map output by the sampling map prediction unit 102 is not limited to the one-dimensional one representing the difficulty of rendering. The sampling map may be two maps that independently output the SPP and resolution or may be a higher-dimensional one. In other words, the sampling map prediction unit 102 may predict a one-dimensional sampling map commonly used for the resolution and SPP, may separately predict the sampling map of the resolution and the sampling map of the SPP, or may further predict a sampling map regarding still other information (e.g., image processing, a point of interest, an importance level of a subject, and/or display information).

Step S105: Determine Rendering Condition from Sampling Map

The rendering condition determination unit 103 determines a rendering condition for each of elements in the pre-rendered image (e.g., for each pixel, for each patch including a plurality of pixels, or for each object region) on the basis of the sampling map indicating the difficulty level of restoration. The rendering condition specifies resolution and SPP for each of elements in the pre-rendered image. The rendering condition determination unit 103 generates an adaptive control signal for setting the determined rendering condition. In other words, the rendering condition determination unit 103 calculates an adaptive control signal for setting an actual rendering condition for each of the elements from the sampling map predicted by the sampling map prediction unit 102.

For example, the rendering condition determination unit 103 only needs to specify a combination of resolution and SPP from the predicted one-dimensional sampling map in accordance with any conversion formula. Alternatively, the rendering condition determination unit 103 only needs to specify resolution and SPP without conversion in a case where two sampling maps, the sampling map of the resolution and the sampling map of the SPP, are predicted. Alternatively, the rendering condition determination unit 103 may convert the sampling map in accordance with any conversion formula under setting conditions (e.g., high speed, high resolution) input by a user (director or viewer).

Step S106: Determine Rendering Condition on Full Screen

The rendering condition determination unit 103 determines a rendering condition for each element of the full screen of the pre-rendered image.

Step S107: Execute Rendering

The rendering unit 104 generates an adaptively rendered image by rendering the model data by ray tracing in accordance with the rendering condition for each of the elements set to the adaptive control signal. That is, the rendering unit 104 generates an adaptively rendered image by rendering the model data for each of the elements at the resolution and SPP defined for each of the elements in accordance with the adaptive control signal. In other words, the rendering unit 104 performs this rendering under the rendering condition defined in accordance with the calculated adaptive control signal. In short, the rendering unit 104 performs rendering while changing the conditions for each of the elements on the basis of a locally optimal combination of SPP and resolution in accordance with the adaptive control signal. The rendering unit 104 basically uses the same renderer (rendering software) as the pre-rendering unit 101. However, the rendering unit 104 may use a different renderer (e.g., a renderer that performs more advanced light ray calculation).

Step S108: Cut Patch from Adaptively Rendered Image

The rendered image restoration unit 105 scans the adaptively rendered image and cuts a plurality of patches from the adaptively rendered image. The patch size equals the input patch size of the restoration DNN. For example, the rendered image restoration unit 105 only needs to cut patches by sequentially raster scanning from the upper left side of the adaptively rendered image. It should be noted that the input patch size of the restoration DNN may be the same as or different from the input patch size of the condition prediction DNN.

Step S109: Input Adaptive Control Signal and Patch to Restoration DNN and Predict Output Image

The rendered image restoration unit 105 inputs the adaptive control signal and the patches cut from the adaptively rendered image to the restoration DNN and predicts an output image for each patch. The rendering condition set to the adaptive control signal specifies resolution and SPP for each of the elements. Therefore, the restoration DNN simultaneously processes two tasks of super resolution and denoising. In other words, the rendered image restoration unit 105 restores the patches by super resolution and denoising. As described in Step S104, the image restoration coefficient 107 has been learned together with the condition prediction coefficient 106. It should be noted that the rendered image restoration unit 105 may use not only the adaptively rendered image but also the sampling map or various AOV images. In that case, it is necessary to previously perform learning under such conditions.

Step S110: Predict Output Image on Full Screen

The rendered image restoration unit 105 predicts an output image for each of all the patches.

Step S111: Output Final Rendering Result

The rendered image restoration unit 105 connects the output images of all the patches subjected to the super resolution and denoising, generates a final rendering result, and outputs it.

### 3. VARIATIONS OF RENDERING CONDITION

In Step S105, the rendering condition determination unit 103 determines a rendering condition for each of the elements in the pre-rendered image from the sampling map and generates an adaptive control signal for setting the determined rendering condition. Various variations of the rendering condition will be described.

3-1. Variation of Rendering Condition Other than SPP and Resolution

The rendering condition determination unit 103 may specify other rendering conditions besides the SPP and resolution as the rendering condition. For example, the rendering condition may further specify the number of images, a bounce rate, the number of refractions in internal transmission, a noise random number sequence, a bit depth, time resolution, on/off of light components, on/off of anti-aliasing, and/or the number of sub-samples. Desirable effects of the restoration DNN depend on the rendering condition adaptively changed. Therefore, adaptive rendering can be performed at higher efficiency or under conditions desired by the user with such a rendering condition.

The number of images means that the SPP is divided in images. For example, generating five sets of 2 SPP makes denoising easier than 10 SPP. In a case where the number of images has been adaptively changed in this manner, the restoration DNN is a DNN that performs not only super resolution and denoising but also fusion of a plurality of images.

The bounce rate means by how many times the number of times of a light ray hitting and reflected on an object should be calculated.

The number of refractions in internal transmission means by how many times the number of refractions should be calculated when a light ray enters a transparent object.

The noise random number sequence means switching between random numbers for the high-range and random numbers for the low-range. Ray tracing uses a technique called Monte Carlo sampling. The Monte Carlo sampling samples in a random direction every time a light ray experiences diffuse scattering or refraction and calculates a result when the light ray travels in that direction. At this time, random numbers of a distribution with some regularity are employed because using white noise in random sampling causes a locally high density. At this time, more advantageous rendering is performed by switching between random numbers for the high-range and random numbers for the low-range in accordance with region properties such as a flat part and a complex part.

The bit depth means whether to use full bits or reduce bits. Since ray tracing performs many hit calculations, calculating full bits every time needs an enormous amount of calculation. Therefore, unnecessary bits are reduced for each pixel.

The time resolution means a frame rate when rendering a moving image.

The on/off of light components means on/off of diffuse-scattered light, reflection light, and/or transmitting light components. Although ray tracing tracks various components in addition to direct light, it turns on/off each component for each pixel.

The on/off of anti-aliasing and the number of sub-samples are settings for anti-aliasing. Ray tracing performs various types of anti-aliasing because simple rendering for each pixel causes jaggies in oblique lines and the like. Techniques called representative supersampling anti-aliasing (SSAA) and multi sample anti-aliasing (MSAA) of them calculate four sub-sample points with respect to one pixel, mix them, and determine a final pixel value. On/off of such an anti-aliasing function and the number of sub-samples can be changed for each pixel.

3-2. Variation in Technique of Determining Rendering Condition

The rendering condition determination unit 103 may determine a rendering condition by using a technique other than learning with the DNN. For example, the rendering condition determination unit 103 may determine a rendering condition by model-based signal processing or external setting and generate an adaptive control signal. Specifically, the rendering condition determination unit 103 may determine a rendering condition on the basis of image processing, a point of interest, an importance level of a subject, and/or display information. Accordingly, the condition can be predicted more simply with lighter weight. Moreover, combining it with the condition prediction DNN can improve the accuracy of the rendering condition.

The rendering condition determination unit 103 may determine a rendering condition on the basis of detection (edges, flatness or the like, brightness, blur (depth), motion amount) depending on a difficulty level of rendering and restoration. Since super resolution and denoising are easily performed on flat part, dark part, blurred part (caused by out-of-focus state or hard move, for example), etc., they can be easily restored even with low resolution or few SPP. Such a region can be detected by known model-based image processing and an adaptive control signal to simplify rendering can be generated.

The rendering condition determination unit 103 may determine a rendering condition on the basis of a point of interest or importance of the subject. The point of interest or important subject is rendered with high resolution and high SPP and other parts can be simplified. Such an adaptive control signal can be generated by detecting it by image processing or by the user specifying it from outside.

The rendering condition determination unit 103 may determine a rendering condition on the basis of preference of a user (director or viewer). The rendering condition determination unit 103 is capable of generating an adaptive control signal to change the rendering condition by specifying it from outside, for example. For example, a setting to allocate more resources for the resolution in a case of prioritizing the resolution or for the SPP in a case of prioritizing noise reduction can be made. Priorities can be set to time resolution, bit depth, anti-aliasing, various components, or the like. In addition, regarding 3D, a setting can be made to prioritize rendering on a part with the effect.

The rendering condition determination unit 103 may determine a rendering condition on the basis of various types of information when displaying 3D or the like. When rendering a multi-viewpoint image for 3D or the like, only important viewpoints such as both ends can be rendered with high resolution and high SPP and other middle viewpoint positions can be rendered more simply. At this time, an occlusion region (region behind a stereoscopic object) and parts where sufficient information cannot be obtained only from viewpoints at both ends such as screen edges are rendered at increased resolution or SPP. An adaptive control signal reflecting such a viewpoint position and the presence/absence of occlusion can be set by external setting and visible calculation.

The rendering condition determination unit 103 may determine a rendering condition in accordance with display characteristics of the display. For example, rendering is performed at the same resolution or ¼ or 1/16 resolution in accordance with the resolution of the display. Rendering according to display characteristics other than the resolution may be performed for special display such as 3D display. For example, in 3D display using lenticular lenses, aliasing or false color occurs depending on a phase relationship between the lenticular lenses and panel pixels. In view of this, an optimal rendering condition can be calculated on the basis of these characteristics and an adaptive control signal can be set.

3-3. Variation in Elements in Pre-Rendered Image in which Common Rendering Condition is Set

The rendering condition determination unit 103 only needs to determine a rendering condition for each pixel, for each patch including a plurality of pixels, or for each object region as for each of elements in the pre-rendered image. This can improve the accuracy of predicting the rendering condition and reduce the calculation time. Although the rendering condition determination unit 103 only needs to set the rendering condition for each pixel basically, the rendering condition may be set for each rectangular patch, for example, instead of the pixel. In the present embodiment, the sampling map prediction unit 102 calculates a sampling map by using the condition prediction DNN. Moreover, the rendered image restoration unit 105 performs restoration (super resolution, denoising) on the adaptively rendered image by using the restoration DNN. These condition prediction DNN and restoration DNN perform processing for each rectangular patch extracted from the input image (pre-rendered image and adaptively rendered image). In view of this, the rendering condition determination unit 103 may determine a rendering condition for each rectangular patch as for each of elements in the pre-rendered image. In this manner, determining the rendering condition for each region including the plurality of pixels, not for each pixel, can improve the accuracy of the adaptive control signal and can also keep continuity between adjacent pixels. It should be noted that this rectangular patch size does not need to equal the patch size of the condition prediction DNN or the restoration DNN. For example, the patch of the condition prediction DNN may be further divided into four parts and integrated or a completely different patch size may be employed. Moreover, a plurality of sampling maps (adaptive control signals) may be used together.

Alternatively, the rendering condition determination unit 103 may determine a rendering condition for each object region as for each of elements in the pre-rendered image. The object region means a region of a meaningful object such as a person unlike the mechanically divided rectangular patch. For example, the rendering condition determination unit 103 is capable of dividing a pre-rendered image pre-rendered with 1 SPP into a plurality of object regions by an existing semantic segmentation technique, integrating pixel-based rendering conditions for the respective regions of the object, and setting a rendering condition for each object. Accordingly, a rendering condition following edges with less overflow can be determined by setting the rendering condition for each object with high accuracy.

3-4. Variation of Timing of Determining Rendering Condition

The rendering condition determination unit 103 may determine a rendering condition for each of some of the elements and the rendering condition for each of the others of the elements may be determined in advance. Some of the rendering conditions can be calculated in advance (before starting the operation flow of FIG. 2), not calculated at the time of pre-rendering. This can reduce the calculation time and can increase the speed of the output processing for each frame and achieve rendering in real time. Such pre-rendering requires conditions for all times and viewpoints in a case of generating animation or free-viewpoint video. All conditions may be calculated or some of them may be cut at any intervals in advance. Moreover, times and viewpoints with high importance levels may be mainly calculated in advance. Moreover, only parts that do not change depending on times and viewpoints may be calculated in advance.

### 4. MODIFIED EXAMPLES

In the present embodiment, the information processing apparatus 100 includes the pre-rendering unit 101, the sampling map prediction unit 102, the rendering condition determination unit 103, the rendering unit 104, and the rendered image restoration unit 105.

Instead, an information processing system in which an information processing apparatus on a server side includes the pre-rendering unit 101, the sampling map prediction unit 102, the rendering condition determination unit 103, and the rendering unit 104 and an information processing apparatus on a client side includes the rendered image restoration unit 105 may be achieved (not shown). The information processing apparatus on the client side is built in or externally connected to a 3D display at an end user site, for example.

In a case of rendering on the server side and transmitting it to the client side, the moving image is sometimes compressed for transmission. At this time, compression deteriorates the rendered image, depending on a transmission band. In this case, an improvement in the rendering quality is useless. Therefore, the rendering condition may be dynamically adaptively changed in accordance with a transmission band. The adaptive control signal at this time can perform not only uniform setting for the full screen in accordance with the band but also setting for each region in accordance with the easiness of compression.

Alternatively, an information processing system in which the information processing apparatus on the server side includes the pre-rendering unit 101, the sampling map prediction unit 102, and the rendering condition determination unit 103 and an information processing apparatus on the client side includes the rendering unit 104 and the rendered image restoration unit 105 may be achieved (not shown). The information processing apparatus on the client side is built in or externally connected to a 3D display at an end user site, for example.

In a case of transmitting the rendering model data from the server side and rendering it on the client side, the adaptive control signal (or the sampling map) may be simultaneously transmitted. This allows optimal adaptive rendering on the client side. Moreover, transmitting the adaptive control signal allows optimal restoration processing also in other cases, e.g., in a case of performing rendering on the server side and restoration processing such as super resolution and denoising on the client side. As a matter of course, the same applies to cases of performing only super resolution, only denoising, or other signal processing.

### 5. CONCLUSION

A technology of predicting a sampling map for adaptively controlling only the SPP is known. However, the effect of reducing the calculation time has a limitation even when adaptively changing only the SPP. For example, as for a flat region, reducing the resolution into ¼ or 1/16 in addition to reducing the SPP can dramatically reduce the calculation time while keeping the image quality. In accordance with the present embodiment, not only the SPP but also the resolution are adaptively controlled for each of the elements. Thus, an optimal combination of SPP and resolution can be locally predicted and adaptively rendered, restoration (denoising and super resolution) can be performed with the restoration DNN, and a final rendered image with the same image quality as a goal image can be output at high speed.

The present disclosure may have the following configurations.
(1) An information processing apparatus, including:
a pre-rendering unit that pre-renders model data by ray tracing and generates a pre-rendered image;
a prediction unit that predicts a difficulty level of restoration in the pre-rendered image;
a rendering condition determination unit that determines a rendering condition on the basis of the difficulty level of the restoration and generates an adaptive control signal for setting the rendering condition, the rendering condition specifying resolution and samples per pixel (SPP) for each of elements in the pre-rendered image;
a rendering unit that generates an adaptively rendered image by rendering the model data by ray tracing in accordance with the rendering condition for each of the elements set to the adaptive control signal; and
a rendered image restoration unit that restores the adaptively rendered image by super resolution and denoising and generates a final rendered image.
(2) The information processing apparatus according to (1), in which
the rendering condition further specifies the number of images, a bounce rate, the number of refractions in internal transmission, a noise random number sequence, bit depth, time resolution, on/off of light components, on/off of anti-aliasing, and/or the number of sub-samples.
(3) The information processing apparatus according to (1) or (2), in which
the rendering condition determination unit determines the rendering condition on the basis of image processing, a point of interest, an importance level of a subject, and/or display information.
(4) The information processing apparatus according to any one of (1) to (3), in which
the rendering condition determination unit determines the rendering condition for each of the elements, for each pixel, for each patch including a plurality of pixels, or for each object region.
(5) The information processing apparatus according to any one of (1) to (4), in which
the rendering condition determination unit determines the rendering condition for each of some of the elements, and
the rendering condition for each of the others of the elements is determined in advance.
(6) The information processing apparatus according to any one of (1) to (5), in which
the prediction unit inputs the pre-rendered image to a condition prediction deep neural network (DNN) and predicts a difficulty level of restoration for each of the elements, and
the rendered image restoration unit inputs the adaptively rendered image and the adaptive control signal to a restoration DNN learned simultaneously with the condition prediction DNN and generates a final rendered image.
(7) The information processing apparatus according to any one of (1) to (6), in which
the prediction unit predicts a sampling map indicating a difficulty level of restoration for each of the elements in the pre-rendered image, and
the rendering condition determination unit generates the adaptive control signal on the basis of the sampling map.
(8) The information processing apparatus according to any one of (1) to (7), in which
the prediction unit predicts a sampling map of the resolution and a sampling map of the SPP, and
the rendering condition determination unit sets a rendering condition of the resolution on the basis of the sampling map of the resolution and sets a rendering condition of the SPP on the basis of the sampling map of the SPP.
(9) The information processing apparatus according to any one of (1) to (7), in which
the prediction unit predicts the sampling map that is one-dimensional, and
the rendering condition determination unit sets the rendering condition of the resolution and the rendering condition of the SPP on the basis of the one-dimensional sampling map.
(10) The information processing apparatus according to any one of (1) to (9), in which
the SPP of the pre-rendered image is lower than the SPP of the final rendered image.
(11) The information processing apparatus according to any one of (1) to (10), in which
the resolution of the pre-rendered image is lower than the resolution of the final rendered image.
(12) An information processing method, including: pre-rendering model data by ray tracing and generating a pre-rendered image;
predicting a difficulty level of restoration in the pre-rendered image;
determining a rendering condition on the basis of the difficulty level of the restoration and generating an adaptive control signal for setting the rendering condition, the rendering condition specifying resolution and samples per pixel (SPP) for each of elements in the pre-rendered image;
generating an adaptively rendered image by rendering the model data by ray tracing in accordance with the rendering condition for each of the elements set to the adaptive control signal; and
restoring the adaptively rendered image by super resolution and denoising and generating a final rendered image.
(13) An information processing program for causing a processor of an information processing apparatus to operate as:
a pre-rendering unit that pre-renders model data by ray tracing and generates a pre-rendered image;
a prediction unit that predicts a difficulty level of restoration in the pre-rendered image;
a rendering condition determination unit that determines a rendering condition on the basis of the difficulty level of the restoration and generates an adaptive control signal for setting the rendering condition, the rendering condition specifying resolution and samples per pixel (SPP) for each of elements in the pre-rendered image;
a rendering unit that generates an adaptively rendered image by rendering the model data by ray tracing in accordance with the rendering condition for each of the elements set to the adaptive control signal; and
a rendered image restoration unit that restores the adaptively rendered image by super resolution and denoising and generates a final rendered image.
(14) An information processing system, including:
a pre-rendering unit that pre-renders model data by ray tracing and generates a pre-rendered image;
a prediction unit that predicts a difficulty level of restoration in the pre-rendered image;
a rendering condition determination unit that determines a rendering condition on the basis of the difficulty level of the restoration and generates an adaptive control signal for setting the rendering condition, the rendering condition specifying resolution and samples per pixel (SPP) for each of elements in the pre-rendered image;
a rendering unit that generates an adaptively rendered image by rendering the model data by ray tracing in accordance with the rendering condition for each of the elements set to the adaptive control signal; and
a rendered image restoration unit that restores the adaptively rendered image by super resolution and denoising and generates a final rendered image.
(15) A non-transitory computer-readable recording medium recording an information processing program for causing a processor of an information processing apparatus to operate as:
a pre-rendering unit that pre-renders model data by ray tracing and generates a pre-rendered image;
a prediction unit that predicts a difficulty level of restoration in the pre-rendered image;
a rendering condition determination unit that determines a rendering condition on the basis of the difficulty level of the restoration and generates an adaptive control signal for setting the rendering condition, the rendering condition specifying resolution and samples per pixel (SPP) for each of elements in the pre-rendered image;
a rendering unit that generates an adaptively rendered image by rendering the model data by ray tracing in accordance with the rendering condition for each of the elements set to the adaptive control signal; and
a rendered image restoration unit that restores the adaptively rendered image by super resolution and denoising and generates a final rendered image.

Although the embodiments and modified examples of the present technology have been described, the present technology is not limited thereto, and various modifications can be made without departing from the gist of the present technology as a matter of course.

### REFERENCE SIGNS LIST

Information processing apparatus 100
Prerendering unit 101
Sampling map prediction unit 102
Rendering condition determination unit 103
Rendering unit 104
Rendering image restoration unit 105
Condition prediction coefficient 106
Image restoration coefficient 107

1. An information processing apparatus, comprising:
a pre-rendering unit that pre-renders model data by ray tracing and generates a pre-rendered image;
a prediction unit that predicts a difficulty level of restoration in the pre-rendered image;
a rendering condition determination unit that determines a rendering condition on a basis of the difficulty level of the restoration and generates an adaptive control signal for setting the rendering condition, the rendering condition specifying resolution and samples per pixel (SPP) for each of elements in the pre-rendered image;
a rendering unit that generates an adaptively rendered image by rendering the model data by ray tracing in accordance with the rendering condition for each of the elements set to the adaptive control signal; and
a rendered image restoration unit that restores the adaptively rendered image by super resolution and denoising and generates a final rendered image.

2. The information processing apparatus according to claim 1, wherein
the rendering condition further specifies the number of images, a bounce rate, the number of refractions in internal transmission, a noise random number sequence, bit depth, time resolution, on/off of light components, on/off of anti-aliasing, and/or the number of sub-samples.

3. The information processing apparatus according to claim 1, wherein
the rendering condition determination unit determines the rendering condition on a basis of image processing, a point of interest, an importance level of a subject, and/or display information.

4. The information processing apparatus according to claim 1, wherein
the rendering condition determination unit determines the rendering condition for each of the elements, for each pixel, for each patch including a plurality of pixels, or for each object region.

5. The information processing apparatus according to claim 1, wherein
the rendering condition determination unit determines the rendering condition for each of some of the elements, and
the rendering condition for each of the others of the elements is determined in advance.

6. The information processing apparatus according to claim 1, wherein
the prediction unit inputs the pre-rendered image to a condition prediction deep neural network (DNN) and predicts a difficulty level of restoration for each of the elements, and
the rendered image restoration unit inputs the adaptively rendered image and the adaptive control signal to a restoration DNN learned simultaneously with the condition prediction DNN and generates a final rendered image.

7. The information processing apparatus according to claim 1, wherein
the prediction unit predicts a sampling map indicating a difficulty level of restoration for each of the elements in the pre-rendered image, and
the rendering condition determination unit generates the adaptive control signal on a basis of the sampling map.

8. The information processing apparatus according to claim 1, wherein
the prediction unit predicts a sampling map of the resolution and a sampling map of the SPP, and
the rendering condition determination unit sets a rendering condition of the resolution on a basis of the sampling map of the resolution and sets a rendering condition of the SPP on a basis of the sampling map of the SPP.

9. The information processing apparatus according to claim 1, wherein
the prediction unit predicts the sampling map that is one-dimensional, and
the rendering condition determination unit sets the rendering condition of the resolution and the rendering condition of the SPP on a basis of the one-dimensional sampling map.

10. The information processing apparatus according to claim 1, wherein
the SPP of the pre-rendered image is lower than the SPP of the final rendered image.

11. The information processing apparatus according to claim 1, wherein
the resolution of the pre-rendered image is lower than the resolution of the final rendered image.

12. An information processing method, comprising:
pre-rendering model data by ray tracing and generating a pre-rendered image;
predicting a difficulty level of restoration in the pre-rendered image;
determining a rendering condition on a basis of the difficulty level of the restoration and generates an adaptive control signal for setting the rendering condition, the rendering condition specifying resolution and samples per pixel (SPP) for each of elements in the pre-rendered image;
generating an adaptively rendered image by rendering the model data by ray tracing in accordance with the rendering condition for each of the elements set to the adaptive control signal; and
restoring the adaptively rendered image by super resolution and denoising and generating a final rendered image.

13. An information processing program for causing a processor of an information processing apparatus to operate as:
a pre-rendering unit that pre-renders model data by ray tracing and generates a pre-rendered image;
a prediction unit that predicts a difficulty level of restoration in the pre-rendered image;
a rendering condition determination unit that determines a rendering condition on a basis of the difficulty level of the restoration and generates an adaptive control signal for setting the rendering condition, the rendering condition specifying resolution and samples per pixel (SPP) for each of elements in the pre-rendered image;
a rendering unit that generates an adaptively rendered image by rendering the model data by ray tracing in accordance with the rendering condition for each of the elements set to the adaptive control signal; and
a rendered image restoration unit that restores the adaptively rendered image by super resolution and denoising and generates a final rendered image.

14. An information processing system, comprising:
a pre-rendering unit that pre-renders model data by ray tracing and generates a pre-rendered image;
a prediction unit that predicts a difficulty level of restoration in the pre-rendered image;
a rendering condition determination unit that determines a rendering condition on a basis of the difficulty level of the restoration and generates an adaptive control signal for setting the rendering condition, the rendering condition specifying resolution and samples per pixel (SPP) for each of elements in the pre-rendered image;
a rendering unit that generates an adaptively rendered image by rendering the model data by ray tracing in accordance with the rendering condition for each of the elements set to the adaptive control signal; and
a rendered image restoration unit that restores the adaptively rendered image by super resolution and denoising and generates a final rendered image.
